(19) United States
(12) Patent Application Publication
(10) Pub. No.: US 2022/0344640 A1
(43) Pub. Date: Oct. 27, 2022

(54) POSITIVE ELECTRODE MATERIAL FOR LITHIUM SECONDARY BATTERY AND LITHIUM SECONDARY BATTERY INCLUDING THE SAME

(71) Applicants: Hyundai Motor Company, Seoul (KR); Kia Corporation, Seoul (KR); Industry Academy Cooperation Foundation of Sejong University, Seoul (KR)

(72) Inventors: Sung Ho Ban, Hwaseong (KR); Ji Eun Lee, Hwaseong (KR); Sang Hun Lee, Paju (KR); Seung Min Oh, Incheon (KR); Woo Young Jin, Busan (KR); Seung Taek Myung, Seoul (KR); Hee Jae Kim, Seoul (KR); Min Young Shin, Seoul (KR)

(21) Appl. No.: 17/532,458

(22) Filed: Nov. 22, 2021

(30) Foreign Application Priority Data
Apr. 26, 2021 (KR) 10-2021-0053624

(51) Int. Cl. H01M 4/36; H01M 4/505; H01M 4/525

(52) U.S. Cl. CPC H01M 4/366; H01M 4/505; H01M 4/525; H01M 2220/20; H01M 2004/028

(57) ABSTRACT

Disclosed herein is a positive electrode material for a lithium (Li) secondary battery. The positive electrode material includes a positive electrode active material including Li—[Mn—Ti]-M—O containing transition metal M to allow reversible intercalation and reversible deintercalation of Li, and the positive electrode active material is coated with Li₃PO₄ to form a coating layer on a surface thereof.

### CROSS REFERENCE TO RELATED APPLICATION

The present application claims priority of Korean Patent Application No. 10-2021-0053624 filed on Apr. 26, 2021, the entire contents of which is incorporated herein for all purposes by this reference.

### TECHNICAL FIELD

The present invention relates to a positive electrode material for a lithium secondary battery and a lithium secondary battery including the same. The positive electrode material may have a high energy density with only a single positive electrode material.

### BACKGROUND

Secondary batteries have been used as large-capacity power storage batteries for electric vehicles or battery power storage systems and used as small and high-performance energy sources for portable electronic devices such as mobile phones, camcorders, and notebook computers. In efforts of reducing the size of portable electronic devices and improve performance in continuous use for a long time, there is a demand for a secondary battery capable of realizing a small size and a high capacity along with research on a reduction in weight of parts and low power consumption.

In particular, a lithium secondary battery, which is a typical secondary battery, has a greater energy density, a larger capacity per area, a lower self-discharge rate, and a longer lifetime than a nickel manganese battery or a nickel cadmium battery. In addition, since there is no memory effect, the lithium secondary battery has a characteristic of convenience of use and a long lifetime.

The lithium secondary battery generates electrical energy due to oxidation and reduction reactions when lithium ions are intercalated/deintercalated from a positive electrode and a negative electrode in a state in which an electrolyte fills between the positive electrode and the negative electrode which are made of an active material capable of intercalation and deintercalation of the lithium ions.

The lithium secondary battery includes a positive electrode material, an electrolyte, a separator, a negative electrode material, and the like, and maintaining a stable interface reaction between the components is very important to secure a long lifetime and reliability of the lithium secondary battery.

As described above, in order to improve performance of the lithium secondary battery, research on improving a positive electrode material has been continuously conducted. In particular, a lot of research has been conducted so as to develop a high-performance and high-safety lithium secondary battery. However, as explosion accidents of lithium secondary batteries occur frequently, safety issues have been continuously raised.

The foregoing is intended merely to aid in understanding of the background of the present invention, and is not intended to mean that the present invention falls within the purview of the related art that is already known to those skilled in the art.

### SUMMARY OF THE INVENTION

In preferred aspects, provided is a positive electrode material for a lithium secondary battery, which may implement a discharge capacity that is greater than a discharge capacity of a conventional positive electrode by coating the positive electrode material with a transition metal without using nickel (Ni) and cobalt (Co).

In an aspect, provided is a positive electrode material for a lithium secondary battery. The positive electrode material may include a positive electrode active material made of Li—[Mn—Ti]-M-O including a transition metal M to allow reversible intercalation and reversible deintercalation of Li, and a coating layer including Li₃PO₄. The positive electrode active material may be coated with the coating layer on a surface thereof.

The positive electrode active material may include Li_{1.25+y}[Mn_{0.45}Ti_{0.35}]_{0.975}Mo_{0.025}O₂ as −0.02≤y≤0.02.

A weight of the coating layer may be about 0.1 to 20 wt % based on the total weight of the positive electrode active material.

The weight of the coating layer may be about 1 to 10 wt % based on the total weight of the positive electrode active material.

The transition metal M may include one more selected from the group consisting of W, Cr, Al, Ni, Fe, Co, V, and Zn.

In another aspect, provided a lithium (Li) secondary battery including a positive electrode including a positive electrode active material as described herein, a negative electrode containing a negative electrode active material, a separator interposed between the positive electrode and the negative electrode, and an electrolyte.

In a further aspect, a vehicle (including an electric-powered vehicle) is provided that comprises an electrolyte material as disclosed herein.

In a yet further aspect, a vehicle (including an electric-powered vehicle) is provided that comprises a battery as disclosed herein.

Other aspects of the invention are disclosed infra.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A to 5B show electrochemical characteristic test results according to an exemplary embodiment of the present invention.

### DETAILED DESCRIPTION

As described herein, objects, other objects, features, and advantages according to the present invention will be readily understood through the following preferred embodiments associated with the accompanying drawings. However, the present invention is not limited to the embodiments described herein and may also be embodied in other forms. Rather, the embodiments introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, a region, or a plate is referred to as being “above” the other portion, it may be not only “right above” the other portion, or but also there may be another portion in the middle. On the contrary, when a portion such as a layer, a film, a region, or a plate is referred to as being “under” the other portion, it may be not only “right under” the other portion, or but also there may be another portion in the middle.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in more detail with reference to the accompanying drawings. However, the present invention may be embodied in many different forms and should not be construed as being limited to the embodiments set forth herein. Rather, these embodiments are provided such that this invention will be thorough and complete and will fully convey the scope of the present invention to those skilled in the art.

In order to improve a capacity of a lithium secondary battery, an NCM-based material is mainly used as a positive electrode active material. In particular, as a ratio of Ni in the NCM-based material is increased, a theoretical capacity of a lithium secondary battery increases. However, as the ratio of Ni is increased, an amount of Ni eluted from a surface of the positive electrode active material is increased, and Ni ions are highly reactive to cause a side reaction on a surface of the positive electrode active material so that there is a problem in that degradation of the lithium secondary battery rapidly proceeds when charging and discharging are repeated.

In an aspect, provided is a positive electrode material that may implement a greater capacity, without using Ni and Co, than a positive electrode material using Ni and Co is synthesized. In particular, a positive electrode material may be synthesized by coating a positive electrode active material made of Li—[Mn—Ti]-M-O containing transition metal M with Li₃PO₄.

The positive electrode active material may include Li_{1.25+y}[Mn_{0.45}Ti_{0.35}]_{0.975}M_{0.025}O₂, which satisfies −0.02≤y≤0.02.

When a given atomic ratio or molar ratio in Li_{1.25+y}[Mn_{0.45}Ti_{0.35}]_{0.975}M_{0.025}O₂ is out of a given numerical range of y, a lot of impurities may be generated due to an excessive of Li, and Li dendrite may be formed.

(NH₄)₃PO₄ may be used to form a coating layer on the surface of the positive electrode active material, and (NH₄)₃PO₄ may react with residual lithium on the surface of the positive electrode active material to form the coating layer made of Li₃PO₄.

The transition metal M constituting the positive electrode active material may include one or more selected from the group consisting of W, Cr, Al, Ni, Fe, Co, V, and Zn. When transition metal having a monovalent oxidation number is included in the positive electrode active material, in consideration of an oxidation number, an amount of Li may increase and thus it is difficult to form a single-phase structure due to an excessive amount of Li, and since transition metal having an oxidation number exceeding hexavalent is a factor destabilizing the positive electrode active material, it is preferable to exclude the transition metal having an oxidation number exceeding hexavalent.

In another aspect, a lithium secondary battery may include a positive electrode including a positive electrode active material including Li—[Mn—Ti]-M-O including a transition metal M to enable reversible intercalation/deintercalation of Li, a negative electrode containing a negative electrode active material, a separator interposed between the positive electrode and the negative electrode, and an electrolyte.

### EXAMPLE

Hereinafter, evaluation on electrochemical performance of a lithium secondary battery manufactured using the positive electrode material will be described.

### Example 1

Li₂CO₃ (input 4.2341 g), Mn₂O₃ (synthesized by inputting 3.2086 g and sintering MnCO₃), TiO₂ (input 2.5387 g), and Al₂O₃ (input 0.11883 g) were mixed with an anhydrous ethanol solvent using a jar of an 80 ml capacity. In this case, a molar ratio of each component was adjusted according to a composition of Li_{1.25}[(Mn_{0.45}Ti_{0.35})_{0.975}Al_{0.025}]O₂. In this case, ZrO₂ balls of 10 mm×10 g, 5 mm×20 g, and 1 mm×8 g were put into. A ball milling condition was 300 rpm/5 h and was performed in seventeen sets, each fifteen minutes. After the ball milling, washing was performed using ethanol, drying was performed, and then pelletization was proceeded. Sintering was performed at a temperature of 900° C. for twelve hours in an Ar atmosphere to yield a powder.

Thereafter, for surface modification, a (NH₄)₃PO₄ material was mixed with the obtained powder at 2.5 wt % compared to the positive electrode active material and then was heat-treated at 300° C. for four hours in an Ar/H₂ atmosphere.

Thereafter, first carbon ball milling (300 rpm/6 h and twenty sets, each fifteen minutes) [active material: acetylene black=9 wt %: 1 wt %, and ZrO₂ ball: 10 mm×10 g, 5 mm×20 g, and 1 mm×4 g] was performed, and then second carbon ball milling (300 rpm/12 h and forty sets, each fifteen minutes) [ZrO₂ ball: 1 mm×11 g] was performed.

The coating layer was made to be 2.5 wt % based on the total weight of the positive electrode active material.

### Example 2

The same manner as in Example 1 was performed, and but the ratio of (NH₄)₃PO₄ was changed to 0.01 wt %. The coating layer was made to be 1.0 wt % based on the total weight of the positive electrode active material.

### Example 3

The same manner as in Example 1 was performed, and but the ratio of (NH₄)₃PO₄ was changed to 0.05 wt %. The coating layer was made to be 5.0 wt % based on the total weight of the positive electrode active material.

### Example 4

The same manner as in Example 1 was performed, and the ratio of (NH₄)₃PO₄ was changed to 0.1 wt %. The coating layer was made to be 10.0 wt % based on the total weight of the positive electrode active material.

### Comparative Example 1

The same manner as in Example 1 was performed, (NH₄)₃PO₄ was not used, and the prepared powder was coated with carbon and completed.

The positive electrode active material synthesized in Examples 1 to 4 and Comparative Example 1 was mixed with a conductive material and a binder and mixed with an NMP solvent, thereby preparing a slurry. Acetylene black was used as a conductive material, and PVDF was used as a binder. A mixing ratio of the active material, the conductive material, and the binder was 85:5:10 by weight. An NMP solvent of 45 μl was put into based on 0.1 g of the total material.

Then, mixing was performed for ten minutes, coating was performed to achieve a thickness of 50 μm, and vacuum drying was performed at a temperature of 110° C. A loading amount of the electrode was set to 1 mg based on 10 Ø.

When a lithium secondary battery was manufactured, a PE separator was used, and a lithium salt in which 1 M LiPF6 was dissolved in an organic solvent mixed at a volume ratio of EC:EMC=30:70 was used as an electrolyte. Graphite was used as a negative electrode material. A coin cell was manufactured and was subjected to an electrochemical performance test.

Charging/Discharging Performance Test of Lithium Secondary Battery

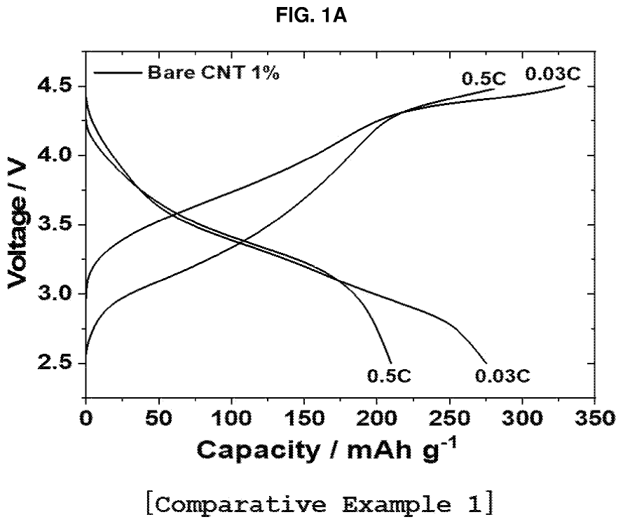

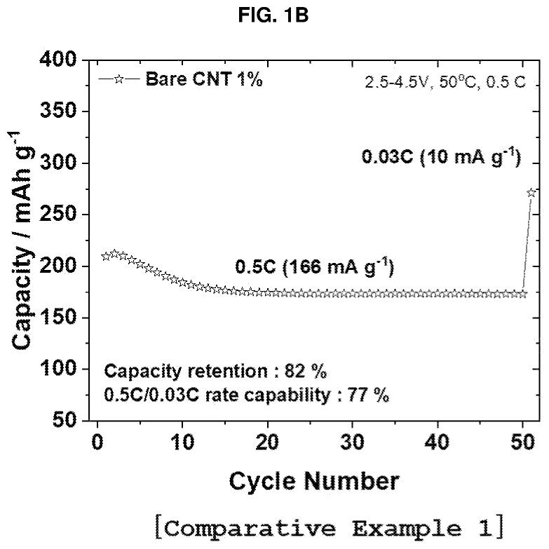

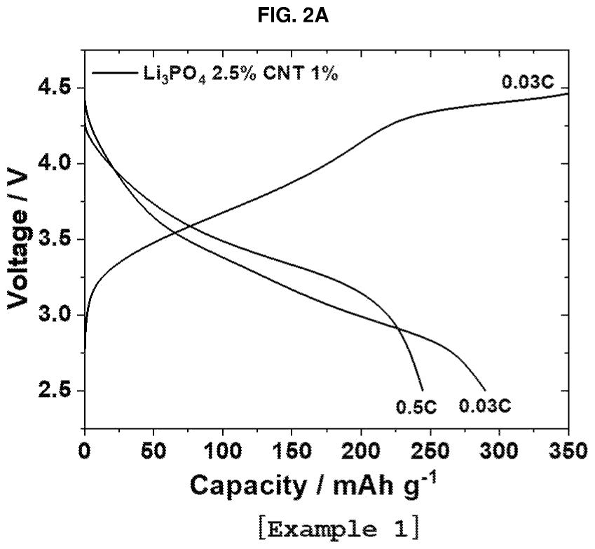

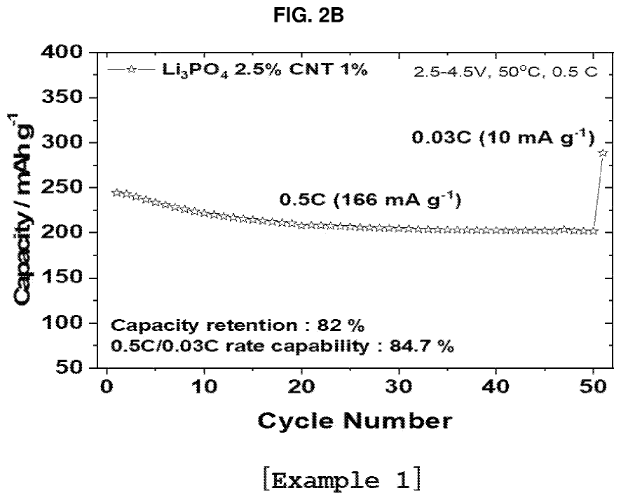

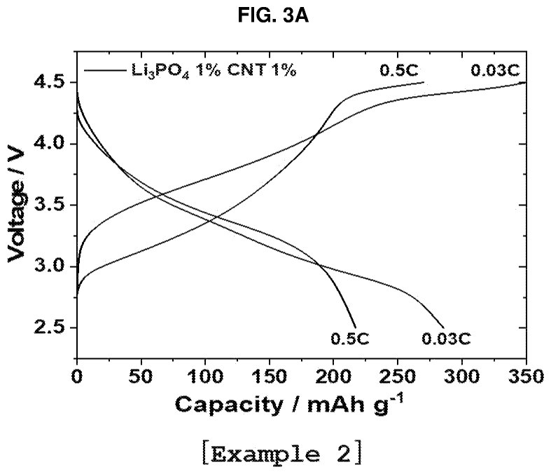

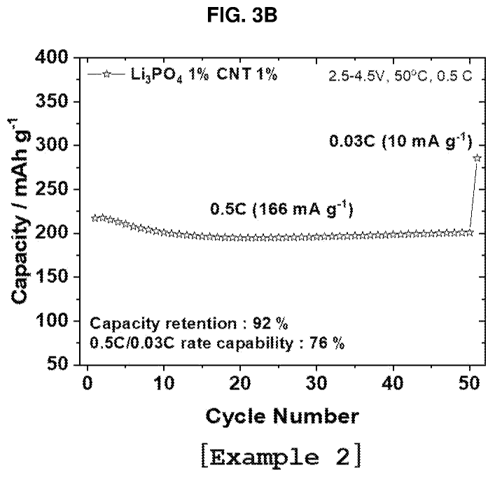

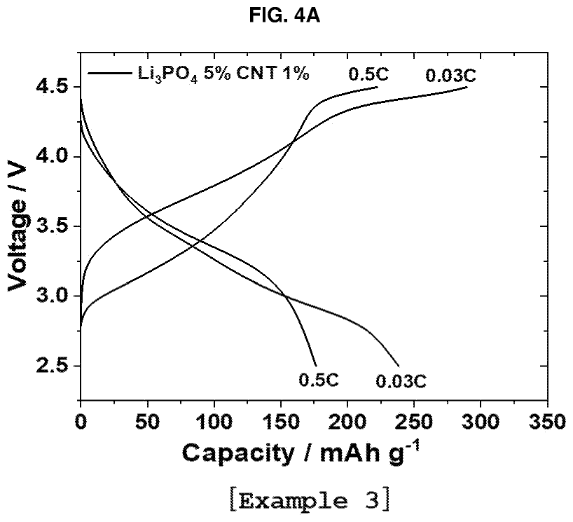

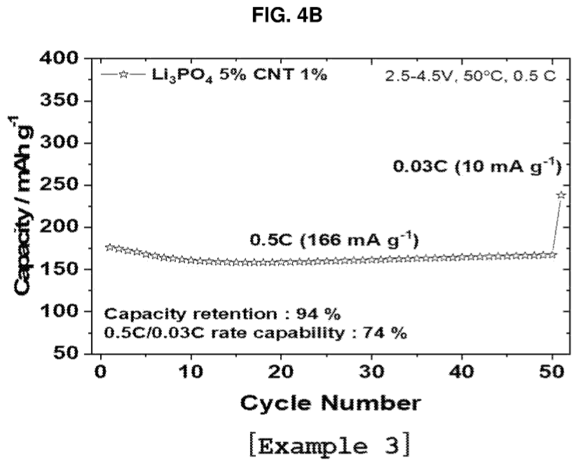

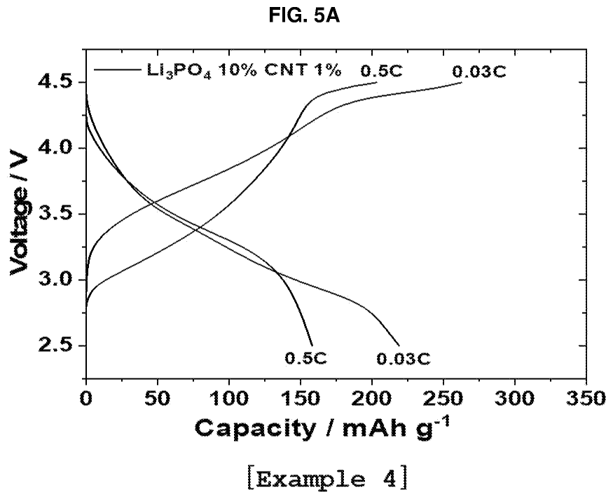

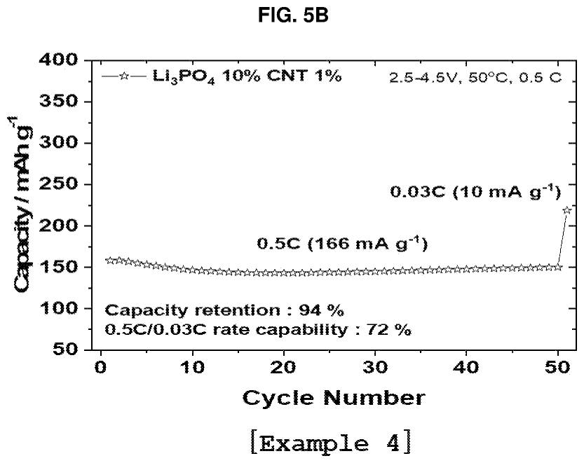

FIGS. 1A, 2A, 3A, 4A, and 5A are graphs showing the results of charging/discharging performance tests with respect to Comparative Example 1, Example 1, Example 2, Example 3, and Example 4, respectively. A discharging termination voltage and a charging termination voltage were set to 2.5 V and 4.5 V, respectively, and initial charging/discharging performance was tested by dividing a rate into 0.03 C and 0.5 C.

Particularly, the charging/discharging performance of Examples 1 and 2 exhibited as values exceeding a value of the charging/discharging performance of Comparative Example 1, and the charging/discharging performance of Examples 3 and 4 exhibited levels that were lower than a level of the charging/discharging performance of Comparative Example 1. It is most preferable that a weight of the coating layer was made to be 1 to 2.5 wt % based on a weight of the positive electrode active material.

High-Temperature Lifetime Characteristic Test of Lithium Secondary Battery

FIGS. 1B, 2B, 3B, 4B, and 5B are graphs showing the results of high-temperature lifetime characteristic tests with respect to Comparative Example 1, Example 1, Example 2, Example 3, and Example 4, respectively. A capacity retention rate was measured at fifty cycles by setting a discharging termination voltage and a charging termination voltage to 2.5 V and 4.5 V, respectively, at a charging/discharging temperature of 50° C. and a rate of 0.5 C.

In particular, the capacity retention rates of Examples 2 to 4 exhibited levels that were greater than the level of the capacity retention rate of Comparative Example 1, and the capacity retention rate of Example 1 exhibited a level that is equal to the level of the capacity retention rate of Comparative Example 1.

According to various exemplary embodiments of the present invention, a positive electrode material which implements a discharge capacity that is greater than a discharge capacity of a conventional positive electrode may be formed without using Ni and Co. Thus, it is possible to expect an effect that a positive electrode material having a high energy density can be implemented.

Although exemplary embodiments of the present invention has been described and illustrated, those skilled in the art will appreciate that various alternations and modifications are possible without departing from the technical spirit of the present invention as disclosed in the appended claims.

What is claimed is:

1. A positive electrode material for a lithium secondary battery, comprising:
a positive electrode active material made of Li—[Mn—Ti]-M-O comprising a transition metal M to allow reversible intercalation and reversible deintercalation of Li, and
a coating layer comprising Li₃PO₄,
wherein the positive electrode active material is coated with the coating layer on a surface thereof.

2. The positive electrode material of claim 1, wherein the positive electrode active material comprises Li_{1.25+y}[Mn_{0.45}Ti_{0.35}]_{0.975}M_{0.025}O₂ wherein −0.02≤y≤0.02.

3. The positive electrode material of claim 1, wherein a weight of the coating layer is about 0.1 to 20 wt % based on the total weight of the positive electrode active material.

4. The positive electrode material of claim 1, wherein a weight of the coating layer is about 1 to 10 wt % based on the weight of the positive electrode active material.

5. The positive electrode material of claim 1, wherein the transition metal M comprises one or more selected from the group consisting of W, Cr, Al, Ni, Fe, Co, V, and Zn.

6. A lithium secondary battery, comprising:
a positive electrode comprising the positive electrode active material of claim 1;
a negative electrode comprising a negative electrode active material;
a separator interposed between the positive electrode and the negative electrode; and
an electrolyte.

7. A vehicle comprising positive electrode active material of claim 1.

8. A vehicle comprising a battery of claim 6.
